(19) United States
(12) Patent Application Publication
(10) Pub. No.: US 2025/0214362 A1
(43) Pub. Date: Jul. 3, 2025

(54) THERMOSENSITIVE RECORDING MEDIUM

(71) Applicants: Nippon Paper Industries Co., Ltd., Tokyo (JP); NIPPON PAPER PAPYLIA CO., LTD., Shizuoka (JP)

(72) Inventors: Kenji HIRAI, Tokyo (JP); Masaki KISHIMOTO, Tokyo (JP); Mitsuyasu YAMAMOTO, Tokyo (JP)

(21) Appl. No.: 18/844,173

(22) PCT Filed: Mar. 27, 2023
(86) PCT No.: PCT/JP2023/012160

§ 371 Date: Sep. 5, 2024

(30) Foreign Application Priority Data
Mar. 31, 2022 (JP) 2022-058563

(51) Int. Cl. B41M 5/333; B41M 5/41; B41M 5/42

(52) U.S. Cl. CPC B41M 5/3336; B41M 5/41; B41M 5/42; B41M 2205/04

(57) ABSTRACT

A thermosensitive recording medium, comprising: a thermosensitive recording layer containing colorless or pale colored electron donating leuco dye and an electron accepting color developing agent on a substrate, wherein the thermosensitive recording layer contains at least one of a urea compound represented by the following general formula (Formula 1) as the electron accepting color developing agent

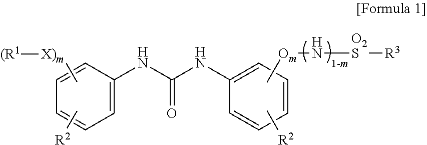

(where, X represents —O— or —NH—, R¹ represents a hydrogen atom or —SO₂—R³, R³ represents a substituted or unsubstituted alkyl group, an aralkyl group or aryl group, R² represents a hydrogen atom or alkyl group, and m represents 0 or 1), and wherein the substrate consists of a paper base material having water dispersibility.

### CROSS REFERENCE TO RELATED APPLICATIONS

This application is a 371 U.S. National Phase of International Application No. PCT/JP2023/012160, filed on Mar. 27, 2023, which claims priority to Japanese Patent Application No. 2022-058563, filed Mar. 31, 2022. The entire disclosures of the above applications are incorporated herein by reference.

### BACKGROUND

### Technical Field

The present invention provides a thermosensitive recording medium including a thermosensitive recording layer on a substrate in which the substrate is a paper base material having water dispersibility. The thermosensitive recording medium has the water dispersibility, excellent reprintability among various performances required for the thermosensitive recording medium, as well as excellent wet and heat resistance, plasticizer resistance, solvent resistance, and the like.

### Related Art

Thermosensitive recording media are ordinarily prepared by applying a coating solution containing an electron donating (hereinafter also referred to as “leuco dye”) and an electron accepting color developing agent (hereinafter also referred to as “color developing agent”) onto a substrate such as paper, synthetic paper, film, plastic and the like. Thermosensitive recording medium develops color through an instantaneous chemical reaction when heated by a thermal head, hot stamp, hot pen, laser light or the like to yield a recorded image. Such thermosensitive recording media are used extensively in recording media such as facsimile devices, computer terminal printers, automatic ticket dispensers, recorders for meters, receipts at super markets and convenience stores and the like.

In recent years, the use of the thermosensitive recording medium is expanding, such as various ticket, receipts, labels, ATM of Bank, meter reading of gas and electricity, cash vouchers, such as car racing or horseracing betting. Therefore, the thermal recording medium is required to have various performances such as water resistance, plasticizer resistance in the image part, heat resistance of blank part, oil resistance, preservation of image and blank parts under harsh conditions, and the like.

In response to such demands, a thermosensitive recording medium in which water resistance, plasticizer resistance of the image part, heat resistance of blank part, etc. are improved by using a combination of two specific types of color developing agents (JP 2015-80852), and a thermosensitive recording medium in which color density, brightness, and storage stability of printed part etc. are improved by using a urea compound as a color developing agent (WO2019/044462, WO2021/095751, and WO2021/171983) have been disclosed.

In addition, a various types of water dispersible sheets have been disclosed (such as WO2018/088179, WO2019/049619, and WO2019/130968).

The present inventors aim to develop a thermosensitive recording medium having water dispersibility and a thermosensitive recording label having an adhesive layer. However, by simply imparting the water dispersibility to a substrate, there is a problem that reprintability is poor (compare reference example 1 with comparative examples 1, 2 described later). Here, the reprintability refers that when printing is performed after the thermosensitive recording medium once produced is stored for predetermined period under high temperature and humidity conditions, it shows effective color development sensitivity.

Therefore, an object of the present invention is to provide a thermosensitive recording medium having the water dispersibility, excellent reprintability among various performances required for the thermosensitive recording medium, as well as excellent wet and heat resistance, plasticizer resistance, solvent resistance, and the like.

### SUMMARY

As a result of intensive studies, the present inventors have found that by having a thermosensitive recording layer contain a specific urea compound as a color developing agent and a specific paper base material having water dispersibility, a thermosensitive recording medium and a thermosensitive recording label having the water dispersibility, excellent reprintability among various performances required for the thermosensitive recording medium, as well as excellent wet and heat resistance, plasticizer resistance, solvent resistance, and the like can be provided, and then completed the present invention.

The present invention provides a thermosensitive recording medium, comprising: a thermosensitive recording layer containing colorless or pale colored electron donating leuco dye and an electron accepting color developing agent on a substrate, wherein the thermosensitive recording layer contains at least one of a urea compound represented by the following general formula (Formula 1) as the electron accepting color developing agent

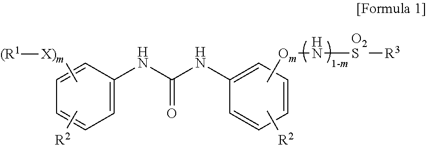

(where, X represents —O— or —NH—, R¹ represents a hydrogen atom or —SO₂—R³, R³ represents a substituted or unsubstituted alkyl group, an aralkyl group or aryl group, R² represents a hydrogen atom or alkyl group, and m represents 0 or 1), and wherein the substrate consists of a paper base material having water dispersibility.

The present invention also provides a thermosensitive recording label wherein an adhesive layer is arranged on a surface opposite to the surface of the substrate on which the thermosensitive recording layer is arranged.

### DETAILED DESCRIPTION

A thermosensitive recording medium of the present invention is a thermosensitive recording medium, comprising: a thermosensitive recording layer on a substrate, wherein the thermosensitive recording layer contains a specific urea compound as the electron accepting color developing agent and a paper base material having water dispersibility is used as the substrate.

As a paper base material (hereinafter also referred to as “base paper”) of the present invention, any of the following (1) to (3) paper base materials is used.

(1) A paper base material including an internal layer and two surface layers arranged on each of both surfaces of the internal layer, in which each surface layer includes mixed pulp including wood pulp and refined pulp including an α cellulose content percentage of 88% by weight or more, in which Canadian Standard Freeness of the mixed pulp is 450 to 600 ml CSF, in which content of the wood pulp in the mixed pulp is 50 to 95% by weight, in which the internal layer includes second mixed pulp including wood pulp and refined pulp including an α cellulose content percentage of 88% by weight or more, in which Canadian Standard Freeness of the second mixed pulp is 600 to 750 ml CSF, and in which content of the wood pulp in the second mixed pulp is 50 to 95% by weight.

Any of the internal layer and the surface layers (including a first surface layer and a second surface layer) consists of the paper base includes the mixed pulp including the wood pulp and the refined pulp including an a cellulose content percentage of 88% by weight or more (hereinafter also referred to as “refined pulp”).

As the wood pulp herein used, wood pulp fiber or non-wood pulp fiber generally used for papermaking can be used, and an α cellulose content percentage is less than 88% by weight. Examples of the wood pulp include wood pulp fiber such as softwood kraft pulp and hardwood kraft pulp, non-wood pulp fiber such as flax pulp, Manila hemp pulp, and kenaf pulp or the like, for example. An average fiber length of the wood pulp is 0.1 to 5 mm, preferably 0.5 to 3 mm, more preferably 0.8 to 2 mm.

The refined pulp herein used refers pulp in which hemicellulose, etc. is removed and cellulose purity is increased by enhancement of digestion conditions upon pulp production, and chemical treatment before or after the digestion, i.e., refined pulp including an α cellulose content percentage of 88% by weight such as mercerized pulp and dissolving pulp using a wood material such as softwood and hardwood or a non-wood material such as flax and linter as a raw material.

With respect to a relationship between the α cellulose content percentage and a hemicellulose content percentage of the pulp, Japanese Unexamined Patent Application Publication 2010-504376 describes that pulp is classified into three grades depending on a degree of refining: an “acetate grade” for highly refined pulp, a “viscose grade for refined pulp, and a “paper/fluff grade” for unrefined pulp, and the content percentage of each grade is described. The “acetate grade” pulp generally includes 95% by weight or more of α cellulose and about 1 to 3% of hemicellulose. The “viscose grade” pulp includes 88 to 95% by weight of α cellulose and about 5 to 12% of hemicellulose. The “paper/fluff grade” pulp includes 80 to 88% by weight of α cellulose and about 12 to 20% of hemicellulose.

From the above, hemicellulose included in the refined pulp used herein is less than 12% by weight.

Note that the pulp is defined in accordance with a general definition of “Aggregate of cellulose fibers extracted from wood or other plant material by mechanical or chemical treatment” (paper and pulp dictionary, 20 Feb. 2000, Japan Technical Association of The Pulp And Paper Industry, ed., KANEHARA & Co., LTD.)

The mercerized pulp is a pulp obtained by immersing kraft pulp or sulfite pulp in a strong alkali solution and then washing with water to remove alkali content.

The dissolving pulp is a pulp having high cellulose purity obtained by sulfite digestion or prehydrolysis kraft digestion, and various cellulose purity level in the pulp can be obtained by combining breaching and fine-selecting treatments after the digestion.

Here, as an indicator of the cellulose purity of the refined pulp, the a cellulose content percentage is used. The α cellulose content percentage of refined pulp should be 88% by weight or more, preferably 92% by weight or more, more preferably 95% by weight or more. If the α cellulose content percentage of refined pulp is less than 88% by weight, the water dispersibility is lowered due to difficulty in dispersing into single fibers. Note that, in the present invention, the α cellulose content percentage is a value measured using α cellulose stipulated by TAPPI standard T203om-83 (JIS P8101-1994 (currently abolished)).

As another indicator of the cellulose purity of the refined pulp, the hemicellulose content percentage may be used. In this case, the hemicellulose content percentage of the refined pulp should be less than 12% by weight, preferably less than 8% by weight, more preferably less than 5% by weight. If the hemicellulose content percentage of the refined pulp is 12% by weight or more, the water dispersibility is lowered due to difficulty in dispersing into single fibers. Note that, in the present invention, the hemicellulose content percentage can be measured by performing acid hydrolysis on the refined pulp or the unrefined pulp to convert into monosaccharides, and quantifying a composition of the monosaccharides by an alditol acetate method. That is, the monosaccharides obtained by the hydrolysis of the pulp is reduced with sodium borohydride to convert into corresponding alditol acetate, which is acetylated with acetic anhydride and pyridine to provide an alditol acetate derivative, and the alditol acetate derivative is then analyzed by a gas chromatography to identify and quantify constituent sugars.

Also, with respect to paper in which the refined pulp and the unrefined pulp are blended, the α cellulose content percentage and the hemicellulose content percentage of the paper can be measured as in the case of each pulp alone. Furthermore, when a fiber form of the pulp is observed and a blend percentage of the refined pulp and the unrefined pulp is determined, the α cellulose content percentage and the hemicellulose content percentage can be calculated for each of the refined pulp and the unrefined pulp.

The mixed pulp herein used does not contain recycled cellulose fiber such as rayon, fibrous carboxyalkyl cellulose, fibrous carboxyalkyl cellulose salt (for example, CMC-Na salt).

The recycled cellulose fiber has insufficient sheet strength and smoothness, which results in poor general printability. The fibrous carboxyalkyl cellulose is acidic, and the acidity has a negative impact depending on intended use. As to the fibrous carboxyalkyl cellulose salt, an alkaline compound remained in the paper base has a negative impact depending on the intended use and discoloration is easy to occur.

Note that such a problem does not arise when a water dispersible sheet is immersed into or coated with a neutral water-soluble polymer solution by a size press coating or so after paper making as described later.

The internal layer that forms the paper base includes the mixed pulp of the wood pulp and the refined pulp containing 88% by weight or more of the α cellulose content percentage, and the content of the wood pulp in the mixed pulp is 50 to 95% by weight, preferably 40 to 70% by weight.

The Canadian Standard Freeness of the mixed pulp used in the internal layer is 600 to 750 ml CSF, preferably 630 to 720 ml CSF. The Canadian Standard Freeness is measured in accordance with JIS P8121-2 2012 (the same applies thereafter).

As beating proceeds (freeness lowers), while fibriration, cutting, and internal swelling of fiber are increased and density, strength, and smoothness of the paper base are increased, the water dispersibility is decreased.

The surface layers (including the first surface layer and the second surface layer) that form the paper base include the mixed pulp including the wood pulp and the refined pulp including an α cellulose content percentage of 88% by weight or more. The Canadian Standard Freeness of the mixed pulp in the surface layer (the first surface layer) on which an adhesive layer is arranged is 450 to 600 ml CSF, preferably 500 to 575 ml CSF, and the content of the wood pulp in the mixed pulp is 50 to 95% by weight, preferably 65 to 80% by weight.

A paper surface pH of the surface layer having such a configuration is 6 to 8 (a neutral range).

On the other hand, the Canadian Standard Freeness of the mixed pulp in the surface layer (the second surface layer) on which no adhesive layer is arranged and the content of the wood pulp in the mixed pulp may be appropriately set depending on an intended purpose. The composition of the second surface layer may be identical as the composition of the first surface layer or may be identical as the composition of the internal layer.

In addition, to make the Canadian Standard Freeness of the mixed pulp used in the internal layer and the surface layers within the above range, the Canadian Standard Freeness of the wood pulp and the Canadian Standard Freeness of the refined pulp may be identical or different. Furthermore, the mixed pulp may be obtained by separately beating the wood pulp and the refined pulp, or by mixing the wood pulp and the refined pulp and then beating.

The surface of the paper base material is immersed into or coated with water-soluble polymer to add the water dispersibility (in particular, fibrous water dispersion time).

When immersing into or coating with the water-soluble polymer, a neutral (pH6 to 8) solution (for example, a neutral water solution) is used.

A non-limiting method of immersing or coating includes a size press coating (generally, 2-roll size press coating), a transfer roll coating, a spray coating, a gravure coating, and a curtain coating. From a productivity standpoint, the size press coating is preferable.

When the surface layer of the water dispersible sheet having the configuration of the present invention is immersed into or coated with the water-soluble polymer, gaps between fibers of the paper base are filled with the water-soluble polymer to increase dry strength of the water dispersible sheet, and the water-soluble polymer present in the gaps between fibers swells upon contact with water to widen the fibers, whereby the fibers can be easily separated.

The water-soluble polymer is preferably one whose dry film is easily re-dissolved in water. Examples include anionic polyelectrolyte salts such as carboxylalkyl cellulose salts, alginates, pectates, polyacrylates, polymethacrylates, carboxyalkylated starch, phosphate-esterified starches, and anionic polyacrylamides, polyelectrolytes such as methyl cellulose, hydroxyalkyl cellulose, polyvinyl alcohol, polyvinyl pyrrolidone, polyalkylene oxide, polyvinyl ethyl ether, hydroxyethylated starch, starch oxide, and alphalated starch, water-soluble polysaccharides such as guar gum, toranto gum, xanthan gum, gum arabic, carrageenan, galactomannan, pullulan, dextran, and dextrin, water-soluble proteins such as gelatin and casein, and others. These can be used alone or in combination with two or more types. Among them, carboxyalkyl cellulose salts are preferably used in terms of water dispersibility improvement and strength improvement.

(2) A paper base material including an internal layer and two surface layers arranged on each of both surfaces of the internal layer, in which the internal layer includes papermaking fiber having the Canadian Standard Freeness of 600 to 750 ml CSF and alkalized fibrous carboxyalkylmethyl cellulose, in which each of the surface layers includes independently the papermaking fiber and the alkalized fibrous carboxyalkylmethyl cellulose, in which the papermaking fiber in at least one surface layer has the Canadian Standard Freeness of 400 to 575 ml CSF, and in which content of the papermaking fiber is 60 to 90% by weight.

The water dispersible sheet of the present invention includes the paper base material (hereinafter also referred as “paper base”) and the adhesive layer, and the paper base includes the internal layer and at least one surface layer. The water dispersibility label includes the adhesive layer on one surface layer (hereinafter also referred to as the “first surface layer”) of the paper base. The water dispersibility label may include the second surface layer on the surface of the internal layer opposite to the first surface layer. FIG. 1 shows a configuration of the water dispersible sheet.

Any of the internal layer and the surface layers (including the first surface layer and the second surface layer) consist of the paper base of the present invention includes the papermaking fiber and the fibrous carboxymethyl cellulose.

Examples of the papermaking fiber include wood pulp fiber or non-wood pulp fiber, for example, wood pulp fiber such as softwood kraft pulp, hardwood kraft pulp, dissolving pulp, and mercerized pulp, non-wood pulp fiber such as flax pulp, Manila hemp pulp, and kenaf pulp, refined cellulose fiber such as Lyocel and the like generally used for the papermaking. The water dispersibility fiber for paper making has the average fiber length of 0.1 to 5 mm, preferably 0.5 to 3 mm, more preferably 0.8 to 2 mm.

The fibrous carboxymethyl cellulose is obtained by carboxy-alkalizing natural cellulose fiber, recycle cellulose fiber, refined cellulose fiber using a known method, and is water insoluble. Specific examples include fibrous carboxymethyl cellulose, fibrous carboxyethyl cellulose and the like. A degree of substitution of a carboxyalkyl group of the fibrous carboxyalkyl cellulose is preferably 0.2 to 1.0, more preferably 0.4 to 0.6.

In the present invention, the fibrous carboxymethyl cellulose is alkalized by using an alkalizing agent. By alkalizing the paper base, water insoluble fibrous carboxyalkyl cellulose in the paper base is converted into an aqueous fibrous carboxyalkyl cellulose salt by a neutralization reaction, the fiber of the paper base is easy to be swollen and disaggregated in water, and the paper base has the water dispersibility.

The alkalizing agent is a solution of an alkali compound and specific examples thereof can include a solution of a hydroxide of an alkali metal such as sodium hydroxide and potassium hydroxide, a carbonates and a bicarbonate of an alkali metal such as sodium carbonate and sodium bicarbonate, an alkali metal phosphate such as sodium hydrogen phosphate, an organic acid salt of an alkali metal such as hydrogen phosphate and sodium acetate, a hydroxide of an alkaline earth metal such as calcium hydroxide, amines such as ammonia, an ammonium salt, and ethanol amine, polyethyleneimie having a molecular weight of 1000 or less, or the like.

The alkalization may be performed by mixing the alkalizing agent with a paper stock liquid at the time of making the paper base, may be performed by spraying the alkalizing agent with a sprayer, coating by using a coater, or adhering to a felt, etc. to be transferred to the paper stock after the paper making, or may be performed by an appropriate preferable method.

Incidentally, the alkalization may be performed such that the first surface layer or the second surface layer contains the alkalizing agent before the adhesive layer is arranged on the paper base, or may be performed such that the second surface layer contains the alkalizing agent after the adhesive layer is arranged on the paper base. In the case where the alkalization is performed at the time of making the paper base as described above, the adhesive layer may be arranged on the first surface layer of the paper base.

In the case where a coating layer described later is arranged on the second surface layer, the second surface layer may contain the alkalizing agent before the coating layer is arranged, and as long as before the adhesive layer is arranged on the paper base, the first surface layer may contain the alkalizing agent after the coating layer is arranged. As described above, in the case where the alkalization is performed at the time of making the paper base, the coating layer may be arranged on the second surface layer.

When the coater is used to coat the paper base with the alkalizing agent, the alkalizing agent is coated using a known coater such as a knife coater, a bar coater, a roll coater, a blade coater, a curtain coater, a champlex coater, and a gravure coater as a solution of the alkali compound or a mixed liquid of an aqueous organic solvent compatible with the solution.

In order to adjust viscosity suitable for the coater used and to prevent the alkali compound from dropping off after drying, a water-soluble polymer compatible with the solution may be blended to the solution of the alkali compound. Examples of the water-soluble polymer include starch and starch derivatives, a cellulose derivative such as a carboxyalkyl cellulose salt, an alginate, a polyacrylate, and the like.

A coating amount of these alkali compounds is preferably neutralizing equivalent of fibrous carboxymethyl cellulose in the base paper or more preferably 1 to 3 times the neutralizing equivalent. If the amount of the alkali compound is below the neutralizing equivalent, the water insoluble fibrous carboxyalkyl cellulose remains, so it is difficult to obtain sufficient water dispersibility and carboxyalkyl cellulose is bound to other carboxyalkyl cellulose with time elapsed, thereby significantly lowering the solubility. If the amount of the alkali compound exceeds 3 times the neutralizing equivalent, it is undesirable in that the base paper is discolored, an appearance of decreased strength, and a material change due to the alkaline compound remained in the base paper.

The content percentage of the alkali compound in the base paper is desirably adjusted as appropriate since it is changed due to a basis weight of the base paper, the degree of substitution and a blend rate of the fibrous carboxyalkyl cellulose, a type of the alkali compound used, and the like. As an example, when the alkali compound is sodium carbonate, the content percentage of the alkali compound is 0.3 to 67% by weight with respect to a weight of the base paper, and when the alkali compound is sodium hydroxide, the content percentage of the alkali compound is 0.2 to 51% by weight with respect to the weight of the base paper.

In order to improve the water dispersibility and the dry strength, the water dispersible sheet (in particular, its base paper) may be immersed into or coated with the water-soluble polymer. For example, when alkalizing the base paper, the water-soluble polymer may be added to the solution of the alkali compound. This allows the gaps between fibers of the base paper to be filled with the water-soluble polymer to increase the dry strength of the water dispersible sheet, and the water-soluble polymer present in the gaps between fibers to be swollen upon contact with water to widen the fibers, whereby the fibers can be easily separated.

The water-soluble polymer is preferably one whose dry film is easily re-dissolved in water. Examples include starch and starch derivatives, a cellulose derivative such as a carboxyalkyl cellulose salt, hydroxyalkyl cellulose, and alkyl cellulose, natural polymer such as an alginate and xanthan gum, a polyacrylate, polyvinyl alcohol, modified polyvinyl alcohol such as carboxy modified polyvinyl alcohol, polyvinyl pyrrolidone, gelatin and casein, and others. These can be used alone or in combination with two or more types. Among them, carboxyalkyl cellulose salts are preferably used in terms of the water dispersibility improvement and the strength improvement.

The internal layer that forms the base paper of the present invention includes the papermaking fiber and the alkalized fibrous carboxymethyl cellulose. The content of the papermaking fiber in the internal layer is preferably 20 to 80% by weight, more preferably 40 to 70% by weight.

The Canadian Standard Freeness of the papermaking fiber used in the internal layers is 600 to 750 ml CSF, preferably 630 to 720 ml CSF. The Canadian Standard Freeness is measured in accordance with JIS P8121-2 2012 (the same applies thereafter).

As the beating proceeds (the freeness lowers), while the fibriration, the cutting, and the internal swelling of fiber are increased and the density, the strength, and the smoothness of the base paper are increased, the water dispersibility is decreased.

The surface layers (including the first surface layer and the second surface layer) that form the base paper include the papermaking fiber and the alkalized fibrous carboxymethyl cellulose.

In addition, the Canadian Standard Freeness of the papermaking fiber in the surface layer (the first surface layer) on which the adhesive layer is arranged is 400 to 575 ml CSF, preferably 425 to 525 ml CSF, and the content of the papermaking fiber is 60 to 90% by weight, preferably 65 to 80% by weight.

On the other hand, the Canadian Standard Freeness of the papermaking fiber in any surface layer (the second surface layer) on which no adhesive layer is arranged and the content of the papermaking fiber may be appropriately set depending on the intended use. The composition of the second surface layer may be identical as the composition of the first surface layer or may be identical as the composition of the internal layer.

(3) A paper base material including a papermaking fiber and alkalized fibrous carboxyalkyl cellulose, and further including a carboxyalkyl cellulose salt, in which a degree of etherification of the fibrous carboxyalkyl cellulose is 0.2 to 0.6, in which a degree of etherification of the carboxyalkyl cellulose salt is 0.5 to 1.6, in which viscosity measured by the Brookfield viscometer of a 1% by weight solution of the carboxyalkyl cellulose salt is 2 to 200 mPa·s, and in which a percentage of the carboxyalkyl cellulose salt to a total of the papermaking fiber and the alkalized fibrous carboxyalkyl cellulose is 0.1 to 10% by weight.

The paper base material includes the papermaking fiber, the alkalized fibrous carboxyalkyl cellulose, and the carboxyalkyl cellulose salt.

Examples of the papermaking fiber include the wood pulp fiber or the non-wood pulp fiber generally used for papermaking: the wood pulp such as the softwood kraft pulp, the hardwood kraft pulp, the dissolving pulp, and the mercerized pulp, the non-wood pulp fiber such as flax pulp, Manila hemp pulp, and kenaf pulp, and refined cellulose fiber such as Lyocel and the like. An average fiber length of the water dispersibility fiber for paper making is 0.1 to 5 mm, preferably 0.5 to 3 mm, more preferably 0.8 to 2 mm.

The Canadian Standard Freeness of the papermaking fiber is preferably 200 to 750 ml CSF, more preferably 350 to 720 ml CSF, still preferably 500 to 700 ml CSF. The Canadian Standard Freeness is measured in accordance with JIS P8121-2:2012 (the same applies thereafter).

As the beating proceeds (the freeness lowers), while the fibriration, the cutting, and the internal swelling of fiber are increased and the density, the strength, and the smoothness of the base paper are increased, the water dispersibility is decreased.

The content of the papermaking fiber in the base paper of the present invention is preferably 20 to 95% by weight, more preferably 30 to 90% by weight, still preferably 40 to 80% by weight.

The fibrous carboxyalkyl cellulose herein used is obtained by carboxyalkylating natural cellulose fiber, recycle cellulose fiber, refined cellulose fiber by a known method, and is water insoluble. Specific examples include fibrous carboxymethyl cellulose, fibrous carboxeyethyl cellulose, and the like.

The degree of etherification (hereinafter also referred to as “DS”) of the fibrous carboxyalkyl cellulose is 0.2 to 0.6, preferably 0.4 to less than 0.6 (i.e., 0.4 or more and less than 0.6). The degree of etherification refers to the degree of substitution of the carboxyalkyl group of the fibrous carboxyalkyl cellulose. If the degree of etherification is low, for example, lower than 0.2, water solubility is not good, and if the degree of etherification is high, for example, higher than 0.6, it may stick to a wire, making the production difficult at the time of making the base paper. Therefore, the fibrous carboxyalkyl cellulose having such a degree of etherification is used in the present invention.

The fibrous carboxyalkyl cellulose is alkalized by using the alkalizing agent. The alkalization is as described above.

In order to improve the water dispersibility of the thermosensitive recording medium (in particular, the thermosensitive recording medium including the adhesive layer), it is preferable that the carboxyalkyl cellulose salt used herein have the viscosity within a specific range. In other words, the viscosity measured by the Brookfield viscometer of the 1% by weight solution of the carboxyalkyl cellulose salt is 2 to 200 mPa·s, preferably 2 to 100 mPa·s. If the viscosity is too high, a film is formed on the surface of the water dispersible sheet, which makes water penetration poor to deteriorate the water dispersibility.

The carboxyalkyl cellulose salt refers to a salt obtained by adding an alkali metal such as sodium and potassium to the carboxyalkyl group of carboxyalkyl cellulose.

Among them, as the carboxyalkyl cellulose salt used in the present invention, the carboxymethyl cellulose salt is preferably used in terms of the water dispersibility improvement and the strength improvement.

The degree of etherification (DS) of the carboxyalkyl cellulose salt is 0.5 to 1.6, preferably 0.6 to 1.0 (i.e., 0.6 or more and 1.0 or less). The higher the degree of etherification of the carboxyalkyl cellulose salt is, for example, when the degree of etherification is about 0.5 to 1.6, the better the water solubility is.

The degree of etherification of the fibrous carboxyalkyl cellulose is preferably lower than the degree of etherification of the carboxyalkyl cellulose salt.

A percentage of the carboxyalkyl cellulose salt to a total of the papermaking fiber and the alkalized fibrous carboxyalkyl cellulose is 0.1 to 10% by weight, preferably 0.5 to 7% by weight. If the percentage of the carboxyalkyl cellulose salt is too high, a film is formed on the surface of the water dispersible sheet, which makes water penetration poor to deteriorate the water dispersibility.

The carboxyalkyl cellulose salt may be added by mixing the carboxyalkyl cellulose salt with the paper stock liquid at the time of making the base paper, may be coated by using the coater or adhered to a felt or the like to transfer to the paper stock after making the base paper, or may be added by any preferable methods as appropriate.

The basis weight of the base paper of the present invention is generally 10 to 200 g/m², and, in particular, the suitable basis weight of the base paper for a coated paper for printing and copying is generally 50 g/m² or more, preferably in the range of 50 to 120 g/m².

In addition, the basis weight of each layer is generally 5 to 100 g/m², preferably in the range of 10 to 100 g/m².

Hereinafter, various materials used in the thermosensitive recording layer of the thermosensitive recording medium of the present invention will be illustrated, however, binders, cross-linking agents, pigments and the like can also be used for other coating layers within the range that does not impair the desired advantages on the above-mentioned problems.

In the thermosensitive recording medium of the present invention, the thermosensitive recording layer contains at least one kind of a urea compound represented by the general formula (Formula 1) as the color developing agent.

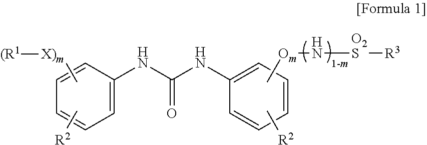

(where, X represents —O— or —NH—, R¹ represents a hydrogen atom or —SO₂—R³, R³ represents a substituted or unsubstituted alkyl group, an aralkyl group or aryl group, R² represents a hydrogen atom or alkyl group, and m represents 0 or 1)

The urea compound is preferably the following general formulae (1) or (2).
(1) A first urea compound represented by the following general formula (Formula 2)

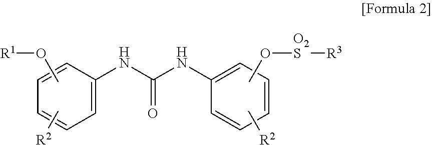

(wherein R¹, R², and R³ are defined as above).
(2) A second urea compound represented by the following general formula (Formula 3)

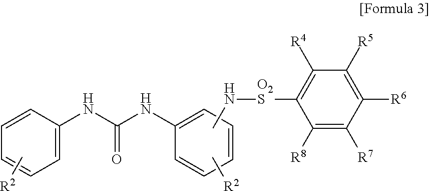

(wherein R² and m are defined as above, and R⁴ to R⁸ are described later).

The first urea compound used in the present invention is preferably represented by the following general formula (Formula 4),

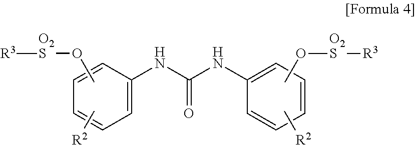

In the general formula (Formula 2) and formula (Formula 4), R² represents an alkyl group, an aralkyl group or an aryl group, all of which may be substituted or unsubstituted, and preferably a substituted or unsubstituted aryl group.

When these are substituted, the substituent is preferably an alkyl group having 1 to 12 carbon atoms, an alkoxy group having 1 to 12 carbon atoms, an aryl group having 6 to 12 carbon atoms or a halogen atom. Further, the plurality of R² may be the same or different.

The position of R¹—O— in the benzene ring in the general formula (Formula 2) may be the same or different, and is preferably the 3-position, 4-position or 5-position.

The position of R¹—SO₂—O— in the benzene ring in the general formula (Formula 2) and general formula (Formula 4) may be the same or different, and is preferably the 3-position, 4-position or 5-position.

The alkyl group is, for example, a linear, branched or alicyclic alkyl group, preferably having 1 to 12 carbon atoms. The alkyl group includes, for example, methyl group, ethyl group, n-propyl group, iso-propyl group, n-butyl group, iso-butyl group, t-butyl group, cyclopentyl group, hexyl group, cyclohexyl group, 2-ethylhexyl group, a lauryl group and the like.

The carbon number of the aralkyl group is preferably 7 to 12. The aralkyl group may be an unsubstituted aralkyl group or an aralkyl group substituted by alkyl group, alkoxy group, aralkyl group, aryl group or halogen atom. Examples thereof include, for example, benzyl group, 1-phenylethyl group, 2-phenylethyl group, 3-phenylpropyl group, p-methylbenzyl group, m-methylbenzyl group, m-ethylbenzyl group, p-ethylbenzyl group, p-iso-propylbenzyl group, p-t-butylbenzyl group, p-methoxybenzyl group, m-methoxybenzyl group, o-methoxybenzyl group, m, p-di-methoxybenzyl group, p-ethoxy-m-methoxybenzyl group, p-phenylmethylbenzyl group, p-cumylbenzyl group, p-phenylbenzyl group, o-phenylbenzyl group, m-phenylbenzyl group, p-tolylbenzyl group, m-tolylbenzyl group, o-tolylbenzyl group and a p-chlorobenzyl group, and the like.

The carbon number of the aryl group is preferably 6 to 12. The aryl group may be an unsubstituted aryl group or an aryl group substituted by alkyl group, alkoxy group, aralkyl group, aryl group or halogen atom. Examples thereof include, for example, phenyl group, p-tolyl group, m-tolyl group, o-tolyl group, 2,5-dimethylphenyl group, 2,4-dimethylphenyl group, 3,5-dimethylphenyl group, 2, 3-dimethylphenyl group, 3,4-dimethylphenyl group, mesitylene group, p-ethylphenyl group, p-iso-propylphenyl group, p-t-butylphenyl group, p-methoxyphenyl group, 3,4-dimethoxyphenyl group, p-ethoxyphenyl group, p-chlorophenyl group, 1-naphthyl group, 2-naphthyl group, t-butylated naphthyl group, and the like.

In the general formula (Formula 1, 2, 4), R³ is preferably a group represented by the following formula:

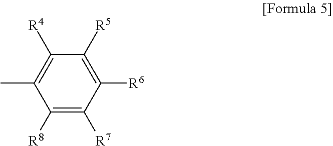

(wherein R⁴ to R⁸ may be identical or different from each other, represent a hydrogen atom, a halogen atom, a nitro group, an amino group, an alkyl group, an alkoxy group, an aryloxy group, an alkylcarbonyloxy group, an arylcarbonyloxy group, an alkylcarbonylamino group, an arylcarbonylamino group, an alkylsulfonylamino group, an arylsulfonylamino group, a monoalkylamino group, a dialkylamino group, or an arylamino group).

R² represents a hydrogen atom or an alkyl group, preferably a hydrogen atom. The alkyl group is preferably an alkyl group having 1 to 4 carbon atoms, which is, for example, methyl group, ethyl group, propyl group, isopropyl group, butyl group, isobutyl group, sec-butyl group, t-butyl group and the like.

The position of R² in the benzene ring in the general formula (Formula 2) may be the same or different, and is preferably 3-position, 4-position, or 5-position.

The first urea compound in the present invention is more preferably the urea compound represented by the following general formula (Formula 6),

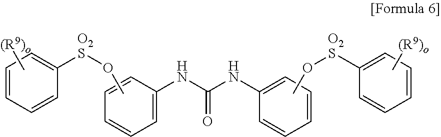

In the general formula (Formula 6), R⁹ is alkyl group or alkoxy group, preferably alkyl group. n represents an integer of 0 to 3, preferably 0 to 2, and more preferably 0 to 1. The number of carbon atoms of the alkyl group is, for example, 1 to 12, preferably 1 to 8, and more preferably 1 to 4.

The position of R⁹ in the benzene ring in the general formula (Formula 6) may be the same or different, and is preferably 3-position, 4-position or 5-position, more preferably 4-position.

Further, the examples of the first urea compound used in the present invention includes, N, N′-di-[3-(benzenesulfonyloxy) phenyl] urea, N, N′-di-[3-(benzenesulfonyloxy)-4-methyl-phenyl] urea, N, N′-di-[3-(benzenesulfonyloxy)-4-ethyl-phenyl] urea, N, N′-di-[3-(benzenesulfonyloxy)-5-methyl-phenyl] urea, N, N′-di-[3-(benzenesulfonyloxy)-4-propyl-phenyl] urea, N, N′-di-[3-(o-toluenesulfonyloxy) phenyl] urea, N, N′-di-[3-(m-toluenesulfonyloxy) phenyl] urea, N, N′-di-[3-(p-toluenesulfonyloxy) phenyl] urea, N, N′-di-[3-(p-toluenesulfonyloxy)-4-methyl-phenyl] urea, N, N′-di-[3-p-xylenesulfonyloxy) phenyl] urea, N, N′-di-[3-(m-xylenesulfonyloxy) phenyl] urea, N, N′-di-[3-(mesitylene sulfonyloxy) phenyl] urea, N, N′-di-[3-(1-naphthalenesulfonyloxy) phenyl] urea, N, N′-di-[3-(2-naphthalenesulfonyloxy) phenyl] urea, N, N′-di-[3-(p-ethylbenzenesulfonyloxy) phenyl] urea, N, N′-di-[3-(p-propylbenzenesulfonyloxy) phenyl] urea, N, N′-di-[3-(p-isopropylbenzenesulfonyloxy) phenyl] urea, N, N′-di-[3-(pt-butylbenzenesulfonyloxy) phenyl] urea, N, N′-di-[3-(p-methoxybenzenesulfonyloxy) phenyl] urea, N, N′-di-[3-(m-methoxybenzenesulfonyloxy) phenyl] urea, N, N′-di-[3-(o-methoxybenzenesulfonyloxy) phenyl] urea, N, N′-di-[3-(m, p-dimethoxybenzenesulfonyloxy) phenyl] urea, N, N′-di-[3-p-ethoxybenzenesulfonyloxy) phenyl] urea, N, N′-di-[3-(p-propoxybenzenesulfonyloxy) phenyl] urea, N, N′-di-[3-(p-butoxybenzenesulfonyloxy) phenyl] urea, N, N′-di-[3-(p-cumylbenzylsulfonyloxy) phenyl] urea, N, N′-di-[3-(p-cumylbenzenesulfonyloxy) phenyl] urea, N, N′-di-[3-(o-phenylbenzenesulfonyloxy) phenyl] urea, N, N′-di-[3-(p-phenylbenzenesulfonyloxy) phenyl] urea, N, N′-di-[3-(p-chlorobenzenesulfonyloxy) phenyl] urea, N, N′-di-[4-(benzenesulfonyloxy) phenyl] urea, N, N′-di-[4-(p-toluenesulfonyloxy) phenyl] urea, N, N′-di-[3-(ethanesulfonyloxy) phenyl] urea, N, N′-di-[3-(benzylsulfonyloxy) phenyl] urea, and the like. However, the first urea compound of the present invention is not limited to these.

The second urea compound used in the present invention is preferably N-[2-(3-phenylureido) phenyl] benzenesulfonamide. The compound is represented by the following formula and is available, for example, under the trade name of NKK 1304 manufactured by Nippon Soda Co., Ltd.

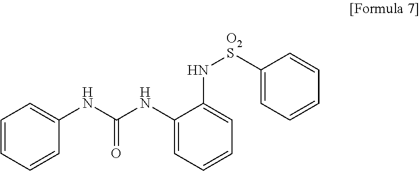 [SMILES: O=C(Nc1ccccc1)Nc1ccccc1NS(=O)(=O)c1ccccc1]

The content (in solid, combined amount when a plurality of urea compounds is contained) of the urea compound in the thermosensitive recording layer of the present invention is from 1.0 to 70.0 weight %, preferably from 5.0 to 65.0 weight %, more preferably 10.0 to 60.0 weight parts.

The content of the first urea compound in the thermosensitive recording layer of the present invention is from 1.0 to 50.0 weight %, preferably 5.0 to 40.0 weight %. The content of the second urea compound is from 5.0 to 50.0 weight %, preferably 5.0 to 40.0 weight %.

In the case when the thermosensitive recording layer of the present invention contains the first and second urea compounds, the content of the second urea compound in the thermosensitive recording layer is preferably 0.1 to 30.0 weight parts, more preferably 0.5 to 25.0 weight parts, further preferably 1.0 to 20.0 weight parts, especially preferably 2.0 to 15.0 weight parts per 1.0 weight parts of the first urea compound.

The thermosensitive recording layer of the present invention may contain color developing agent(s) other than the first urea compound and the second urea compound. As such color developing agents, for example, activated clay, attapulgite, colloidal silica, inorganic acidic substances such as aluminum silicate and the like, 4,4′-isopropylidene diphenol, 1,1-bis(4-hydroxyphenyl) cyclohexane, 2,2-bis(4-hydroxyphenyl)-4-methylpentane, 4,4′-dihydroxydiphenyl sulfide, hydroquinone monobenzyl ether, benzyl 4-hydroxybenzoate, 4,4′-dihydroxy diphenyl sulfone, 2,4′-dihydroxy diphenyl sulfone, 4-hydroxy-4′-isopropoxy diphenyl sulfone, 4-hydroxy-4′-n-propoxy diphenyl sulfone, bis(3-allyl-4-hydroxyphenyl) sulfone, 4-hydroxy-4′-methyldiphenyl sulfone, 4-hydroxyphenyl-4′-benzyloxy phenyl sulfone, 3,4-dihydroxyphenyl-4′-methyl phenyl sulfone, 1-[4-(4-hydroxyphenyl-sulfonyl) phenoxy]-4-[4-(4-isopropoxyphenyl sulfonyl) phenoxy] butane, phenol condensate composition described in Japanese Patent Application Public Disclosure No. 2003-154760, aminobenzene sulfonamide derivatives described in Japanese Patent Application Public Disclosure No. H08-59603, bis(4-hydroxyphenyl thioethoxy) methane, 1,5-di(4-hydroxyphenyl thio)-3-oxapentane, butyl bis(p-hydroxyphenyl) acetate, methyl bis(p-hydroxyphenyl) acetate, 1,1-bis(4-hydroxyphenyl)-1-phenyl ethane, 1,4-bis[α-methyl-α-(4′-hydroxyphenyl)ethyl] benzene, 1,3-bis[α-methyl-α-(4′-hydroxyphenyl)ethyl] benzene, di(4-hydroxy-3-methylphenyl) sulfide, 2,2′-thiobis(3-tert-octylphenol), 2,2′-thiobis(4-tert-octylphenol), compounds described in International Publication WO02/081229 or Japanese Patent Application Public Disclosure No. 2002-301873, thiourea compounds such as N,N′-di-m-chlorophenyl thiourea and the like, p-chlorobenzoic acid, stearyl gallate, bis[zinc 4-octyloxy carbonylamino salicylate] dehydrate, 4-[2-(p-methoxyphenoxy) ethyloxy] salicylic acid, 4-[3-(p-tolylsulfonyl) propyloxy] salicylic acid, aromatic carboxylic acids such as 5-[p-(2-p-methoxyphenoxyethoxy) cumyl] salicylic acid, and salts of these aromatic carboxylic acids and polyvalent metals such as zinc, magnesium, aluminum, calcium, titanium, manganese, tin, nickel and the like, and, furthermore, antipirin complexes of zinc thiocyanate and complex zinc salts of terephthal aldehyde acid with other aromatic carboxylic acids and the like may be cited. These color developing agents may be used individually or as a mixture of at least two of them.

1-[4-(4-hydroxyphenyl-sulfonyl) phenoxy]-4-[4-(4-isopropoxyphenyl sulfonyl) phenoxy] butane is available, for example, under the trade name of JKY-214 produced by API Corporation. The phenol condensate composition described in Japanese Patent Application Public Disclosure No. 2003-154760 is available, for example, under the trade name of JKY-224 produced by API Corporation. The compound described in International Publication WO02/081229 is available, for example, under the trade names of NKK-395 and D-100 produced by Nippon Soda Co., Ltd. In addition, high molecular weight aliphatic acid metal complex salts described in Japanese Patent Application Public Disclosure No. H10-258577 and metal chelate type color developing components such as polyvalent hydroxy aromatic compounds and the like may also be present.

In the case when the thermosensitive recording layer contains color developing agent other than the first ore second urea compound, the combined amount (in solid) of the first and/or second urea compound used is preferably 50 weight % or more, more preferably 80 weight % or more, further preferably 90 weight % or more of the total amount of the color developing agents contained in the thermosensitive recording layer (which contains the first and/or second urea compound).

All of the leuco dyes well known in the conventional field of pressure sensitive and thermosensitive recording media may be used as the electron donating leuco dye in the present invention. Although the leuco dye is not particularly restricted, triphenylmethane type compounds, fluorane type compounds, fluorene type compounds, divinyl type compounds and the like are preferred as the leuco dye. Specific examples of the typical colorless to pale colored basic colorless leuco dye (leuco dye precursors) are shown below. In addition, these leuco dye precursors may be used individually and also in mixtures of at least two of them.

### <Triphenylmethane Type Leuco Dyes>

3,3-bis(p-Dimethyl aminophenyl)-6-dimethylaminophthalide [alternate name: crystal violet lactone] and 3,3-bis(p-Dimethyl aminophenyl) phthalide [alternate name: malachite green lactone]

### <Fluorane Type Leuco Dyes>

3-Diethylamino-6-methylfluorane, 3-diethylamino-6-methyl-7-anilinofluorane, 3-diethylamino-6-methyl-7-(o,p-dimethylanilino)fluorane, 3-diethylamino-6-methyl-7-chlorofluoran, 3-diethylamino-6-methyl-7-(m-trifluoromethylanilino) fluorane, 3-diethylamino-6-methyl-7-(o-chloroanilino) fluorane, 3-diethylamino-6-methyl-7-(p-chloroanilino) fluorane, 3-diethylamino-6-methyl-7-(o-fluoroanilino) fluorane, 3-diethylamino-6-methyl-7-(m-methylanilino) fluorane, 3-diethylamino-6-methyl-7-n-octylanilino fluorane, 3-diethylamino-6-methyl-7-n-octylamino fluorane, 3-diethylamino-6-methyl-7-benzylamino fluorane, 3-diethylamino-6-methyl-7-dibenzylamino fluorane, 3-diethylamino-6-chloro-7-methyl fluorane, 3-diethylamino-6-chloro-7-anilino fluorane, 3-diethylamino-6-chloro-7-p-methylanilino fluorane, 3-diethylamino-6-ethoxyethyl-7-anilino fluorane, 3-diethylamino-7-methyl fluorane, 3-diethylamino-7-chloro fluorane, 3-diethylamino-7-(m-trifluoromethylanilino) fluorane, 3-diethylamino-7-(o-chloroanilino) fluorane, 3-diethylamino-7-(p-chloroanilino) fluorane, 3-diethylamino-7-(o-fluoroanilino) fluorane, 3-diethylamino-benz[a] fluorane, 3-diethylamino-benz[c] fluorane, 3-dibutylamino-6-methyl-fluorane, 3-dibutylamino-6-methyl-7-anilino fluorane, 3-dibutylamino-6-methyl-7-(o,p-dimethylanilino) fluorane, 3-dibutylamino-7-(o-chloroanilino) fluorane, 3-butylamino-6-methyl-7-(p-chloroanilino) fluorane, 3-dibutylamino-6-methyl-7-(o-fluoroanilino) fluorane, 3-dibutylamino-6-methyl-7-(m-fluoroanilino) fluorane, 3-dibutylamino-6-methyl-chloro fluorane, 3-dibutylamino-6-ethoxyethyl-7-anilino fluorane, 3-dibutylamino-6-chloro-7-anilino fluorane, 3-dibutylamino-6-methyl-7-p-methylanilino fluorane, 3-dibutylamino-7-(o-chloroanilino) fluorane, 3-dibutylamino-7-(o-fluoroanilino) fluorane, 3-di-n-pentylamino-6-methyl-7-anilino fluorane, 3-di-n-pentylamino-6-methyl-7-(p-chloroanilino) fluorane, 3-di-n-pentylamino-7-(m-trifluoromethylanilino) fluorane, 3-di-n-pentylamino-6-chloro-7-anilino fluorane, 3-di-n-pentylamino-7-(p-chloroanilino) fluorane, 3-pyrolidino-6-methyl-7-anilino fluorane, 3-piperidino-6-methyl-7-anilino fluorane, 3-(N-methyl-N-propylamino)-6-methyl-7-anilino fluorane, 3-(N-methyl-N-cyclohexylamino)-6-methyl-7-anilino fluorane, 3-(N-ethyl-N-cyclohexylamino)-6-methyl-7-anilino fluorane, 3-(N-ethyl-N-xylylamino)-6-methyl-7-(p-chloroanilino) fluorane, 3-(N-ethyl-p-toluidino)-6-methyl-7-anilino fluorane, 3-(N-ethyl-N-isoamylamino)-6-methyl-7-anilino fluorane, 3-(N-ethyl-N-isoamylamino)-6-chloro-7-anilino fluorane, 3-(N-ethyl-N-tetrahydrofurfurylamino)-6-methyl-7-anilino fluorane, 3-(N-ethyl-N-isobutylamino)-6-methyl-7-anilino fluorane, 3-(N-ethyl-N-ethoxypropylamino)-6-methyl-7-anilino fluorane, 3-cyclohexylamino-6-chloro fluorane, 2-(4-oxahexyl)-3-dimethylamino-6-methyl-7-anilino fluorane, 2-(4-oxahexyl)-3-diethylamino-6-methyl-7-anilino fluorane, 2-(4-oxahexyl)-3-dipropylamino-6-methyl-7-anilino fluorane, 2-methyl-6-o-(p-dimethylaminophenyl) aminoanilino fluorane, 2-methoxy-6-p-(p-dimethylaminophenyl) aminoanilino fluorane, 2-chloro-3-methyl-6-p-(p-phenylaminophenyl) aminoanilino fluorane, 2-chloro-6-p-(p-dimethylaminophenyl) aminoanilino fluorane, 2-nitro-6-p-(p-diethylaminophenyl) aminoanilino fluorane, 2-amino-6-p-(p-diethylaminophenyl) aminoanilino fluorane, 2-diethylamino-6-p-(p-diethylaminophenyl) aminoanilino fluorane, 2-phenyl-6-methyl-6-p-(p-phenylaminophenyl) aminoanilino fluorane, 2-benzyl-6-p-(p-phenylaminophenyl) aminoanilino fluorane, 2-hydroxy-6-p-(p-phenylaminophenyl)aminoanilino fluorane, 3-methyl-6-p-(p-dimethylaminophenyl) aminoanilino fluorane, 3-diethylamino-6-p-(p-diethylaminophenyl) aminoanilino fluorane, 3-diethylamino-6-p-(p-dibutylaminophenyl) aminoanilino fluorane and 2,4-dimethyl-6-[(4-dimethylamino) anilino] fluorane.

### <Fluorene Type Leuco Dye>

3,6,6-Tris(dimethylamino) spiro[fluorane-9,3′-phthalide] and 3,6,6′-tris (diethylamino) spiro[fluorane-9,3′-phthalide].

### <Divinyl Type Leuco Dyes>

3,3-bis-[2-(p-dimethylaminophenyl)-2-(p-methoxyphenyl) ethenyl]-4,5,6,7-tetrabromophthalide, 3,3-bis-[2-(p-dimethylaminophenyl)-2-(p-methoxyphenyl) ethenyl]-4,5,6,7-tetrachlorophthalide, 3,3-bis-[1,1-bis (4-pyrrolidinophenyl) ethylene-2-yl] 4,5,6,7-tetra-bromophthalide, 3,3-bis-[1-(4-methoxyphenyl)-1-(4-pyrrolidinophenyl) ethylene-2-yl]-4,5,6,7-tetrachlorophthalide

### <Others>

3-(4-Diethylamino-2-ethoxyphenyl)-3-(1-ethyl-2-methylindol-3-yl)-4-azaphthalide, 3-(4-diethylamino-2-ethoxyphenyl)-3-(1-octyl-2-methylindol-3-yl)-4-azaphthalide, 3-(4-cyclohexyl ethylamino-2-methoxyphenyl)-3-(1-ethyl-2-methylindol-3-yl)-4-azaphthalide, 3,3-bis(1-ethyl-2-methylindol-3-yl)phthalide, 3,6-bis(diethylamino)fluorane-γ-(3′-nitroanilinolactam, 3,6-bis(diethylamino)fluorane-γ-(4′-nitro) anilinolactam, 1,1-bis-[2′,2′,2″,2″-tetrakis-(p-thmethylaminophenyl)-ethenyl]-2,2-dinitrilethane, 1,1-bis-[2′,2′,2″,2″-tetrakis-(p-thmethylaminophenyl)-ethenyl]-2-ß-naphthoyl ethane, 1,1-bis-[2′,2′,2″,2″-tetrakis-(p-thmethylaminophenyl)-ethenyl]-2,2-thacetylethane and bis-[2,2,2′,2′-tetrakis-(p-dimethylaminophenyl)-ethenyl]-methylmalonic acid dimethyl ester.

The previously wellknown sensitizers may be used as the sensitizer in the thermosensitive recording medium of the present invention. As such sensitizers, aliphatic acid amides such as stearic acid amide, palmitic acid amide and the like, ethylene bis-amide, montan acid wax, polyethylene wax, 1,2-di-(3-methylphenoxy) ethane, p-benzyl biphenyl, ß-benzyloxy naphthalene, 4-biphenyl-p-tolyl ether, m-terphenyl, 1,2-diphenoxyethane, dibenzyl oxalate, di(p-chlorobenzyl) oxalate, di(p-methylbenzyl) oxalate, dibenzyl terephthalate, benzyl p-benzyloxy benzoate, di-p-tolyl carbonate, phenyl-α-naphthyl carbonate, 1,4-diethoxynaphthalene, 1-hydroxy-2-naphthoic acid phenyl ester, o-xylene-bis-(phenyl ether), 4-(m-methyl phenoxymethyl) biphenyl, 4,4′-ethylene dioxy-bis-benzoic acid dibenzyl ester, dibenzoyloxy methane, 1,2-di(3-methylphenoxy) ethylene, bis[2-(4-methoxy-phenoxy) ethyl] ether, methyl p-nitrobenzoate, phenyl p-toluene sulfonate, o-toluenesulfonamide, p-toluenesulfonamide, and the like may be listed as examples. These sensitizers may be used individually and as mixtures of at least two of them.

As a pigment used in the present invention, kaolin, calcined kaolin, calcium carbonate, aluminum oxide, titanium oxide, magnesium carbonate, aluminum silicate, magnesium silicate, calcium silicate, aluminum hydroxide, silica and the like may be used. These pigments may be used in combinations depending on the required quality.

As the binder used in the present invention, completely saponified polyvinyl alcohol, partially saponified polyvinyl alcohol, modified polyvinyl alcohols such as acetoacetylated polyvinyl alcohol, carboxy-modified polyvinyl alcohol, amide-modified polyvinyl alcohol, sulfonic acid-modified polyvinyl alcohol, butyral-modified polyvinyl alcohol, olefin-modified polyvinyl alcohol, nitrile-modified polyvinyl alcohol, pyrolidone-modified polyvinyl alcohol, silicone-modified polyvinyl alcohol, other modified polyvinyl alcohol, hydroxyethyl cellulose, methyl cellulose, ethyl cellulose, carboxymethyl cellulose,-styrene-maleic anhydride copolymer, styrene-butadiene copolymer, cellulose derivatives such as ethyl cellulose and acetyl cellulose, casein, gum Arabic, oxidized starch, etherified starch, dialdehyde starch, esterified starch, polyvinyl chloride, polyvinyl acetate, polyacrylamide, polyacrylic acid ester, polyvinyl butylal, polystyrol and their copolymers, silicone resins, petroleum resins, terpene resins, ketone resins, cumaron resins and the like may be listed as examples. The polymeric substances may be used upon dissolving them in a solvent such as water, alcohol, ketones, esters, hydrocarbons and the like or upon emulsifying or dispersing into a paste in water or other media. These polymeric materials may also be used in combinations according to the qualities demanded.

As the lubricant used in the present invention, fatty acid metal salts such as zinc stearate, calcium stearate, and the like, waxes, silicone resins, and the like may be cited.

Stabilizing agents that improve oil resistance of recorded images and the like, such as 4,4′-butylidene (6-t-butyl-3-methylphenol), 2,2′-di-t-butyl-5,5′-dimethyl-4,4′-sulfonyl diphenol, 1,1,3-tris (2-methyl-4-hydroxy-5-cyclohexylphenyl) butane, 1,1,3-tris (2-methyl-4-hydroxy-5-t-butylphenyl) butane and the like may also be added in the range that does not adversely affect the desired effects for the problems described above.

In addition, a benzophenone type and triazole type UV absorbers, dispersion agent, de-foaming agent, antioxidant, fluorescent dye and the like may also be used.

The types and amounts of the leuco dye, color developing agent, sensitizer and other various ingredients used in the thermosensitive recording medium of the present invention may be determined according to the required performance and printability. Although the amounts of the color developing agent, the sensitizer, the pigment, the stabilizing agent and the other ingredients are not particularly restricted, from 0.5 parts to 10 parts of the color developing agent, from 0.1 parts to 10 parts of the sensitizer, from 0.5 parts to 20 parts of the pigment, from 0.01 parts to 10 parts of the stabilizing agent and from 0.01 parts to 10 parts of the other ingredients are ordinarily used per 1 part of the leuco dye. The content (in solid) of the binders in the thermosensitive recording layer is suitably around from 5 to 25 weight %.

The leuco dye, the color developing agent and the other materials added as needed are finely ground into particles with several microns or smaller in size, by using a grinder or a suitable emulsification device such as a ball mill, attritor, sand grinder and the like. The coating solutions are prepared by adding a binder and various additives to these depending on the objective. Water, alcohol and the like can be used as the solvent for the coating solution and the content (in solid) of the coating solution is about from 20 to 40 weight %.

In addition, in the thermosensitive recording medium of the present invention, the adhesive layer may be arranged on a surface opposite to the surface of the substrate on which the thermosensitive recording layer is arranged, thereby providing a thermosensitive recording label.

As an adhesive agent of the adhesive layer, an adhesive agent having the water solubility or water redispersibility, in particular, a water-soluble acrylic adhesive agent is preferably used.

Examples of the water-soluble acrylic adhesive agent include as a base polymer a copolymer including alkoxyalkyl acrylate, styrene sulfonate, and other copolymeric monomer, and a copolymer including a carboxyl group-containing vinylic monomer such as (meth)acrylic acid, a hydroxyl group-containing monomer, and optionally a copolymer with other copolymeric monomer. Examples of the redispersible acrylic adhesive agent includes as a base polymer a copolymer including a (meth)acrylic acid alkyl ester, a carboxyl group-containing vinylic monomer, an alkoxy group-containing vinylic monomer, and optionally other copolymeric monomer; and a copolymer in which a vinyl monomer containing carboxylated rosin ester, a carboxyl group-containing vinyl monomer and a water-soluble vinyl monomer are copolymerized. Note that the carboxyl groups of these copolymers may be a salt type; a part or all thereof may be neutralized with alkali as necessary. An alkali metal salt; an amine salt, an alkanolamine salt as the alkali being preferably used.

The water-soluble acrylic adhesive agent may be blended with a cross-linking agent for adjusting adhesive strength, the water solubility or the water dispersibility. Such a cross-linking agent is not especially limited, and any cross-linking agent conventionally and customarily used in the acrylic adhesive agent can be appropriately selected and used. Examples include an isocyanate cross-linking agent such as 1,2-ethylene diisocyanate, an epoxy cross-linking agent such as diglycidyl ethers, as well as, melamine resin, urea resin, dialdehydes, a methylol polymer, a metal chelate compound, a metal alkoxide, and a metal salt. In addition, in order to adjust properties and improve performances, the acrylic adhesive agent may be appropriately blended with conventionally known plasticizer, an adhesion enhancer, a colorant, a thickener, a defoamer, a leveling agent, a plasticizer, a mold inhibitor, an antioxidant as necessary. Here, the plasticizer and the adhesion enhancer preferably have the water solubility or the water dispersibility. Examples of the plasticizer include polyhydric alcohols such as sugar alcohols, polyether polyols, alkanolamine salts of rosin oxide. Examples of the adhesion enhancer include alkali metal salts of rosin, disproportionated rosin, and hydrogenated rosin, ammonium salts, and polyetheresters.

The thermosensitive recording medium of the present invention may further have a protective layer on the thermosensitive recording layer. The protective layer comprises mainly a binder and a pigment, and the binder, the pigment, the cross-linking agent or the like described as being usable for the thermosensitive recording layer can be used.

Any binder that can be used in the thermosensitive recording layer described above can be used as the binder, but carboxy-modified polyvinyl alcohol and non-core-shell type acrylic resin are preferably used. These binders may be used solely or in combination of two or more.

Any cross-linking agent that can be used in the thermosensitive recording layer described above can be used as the cross-linking agent, and epichlorohydrin-based resin and polyamine/polyamide-based resin (excluding those categorized as epichlorohydrin-based resin) are preferably used.

It is more preferable that the protective layer contains an epichlorohydrin-based resin and a polyamine/polyamide-based resin together with a carboxy-modified polyvinyl alcohol, which further improves the color developing property.

The carboxy modified poly(vinyl alcohol) is, for example, obtained in the form of a reaction product of poly(vinyl alcohol) and a polyvalent carboxylic acid such as fumaric acid, phthalic anhydride, mellitic anhydride, itaconic anhydride and the like or as esterified materials of these reaction products or, furthermore, in the form of saponified materials of the copolymers of vinyl acetate with an ethylenic unsaturated dicarboxylic acid such as maleic acid, fumaric acid, itaconic acid, crotonic acid, acrylic acid, methacrylic acid and the like. More specifically, the production processes listed as examples in Example 1 or Example 4 in, for example, Japanese Patent Application Public Disclosure S53-91995 may be cited. In addition, a degree of saponification of from 72 to 100 mole % is preferred for the carboxy-modified poly(vinyl alcohol). A degree of polymerization is preferably from 500 to 2400, more preferably 1000 to 2000.

The glass transition point (Tg) of the non-core-shell type acrylic resin is preferably 95 degree C. or lower, and further preferably 50 degree C. or higher. The Tg is measured by differential scanning calorimetry (DSC).

The non-core shell type acrylic resin contains (meth) acrylic acid and a monomer component copolymerizable with (meth) acrylic acid, and the content of the (meth) acrylic acid is preferably from 1 to 10 parts by weight per 100 parts by weight of the non-core shell type acrylic resin. (Meta) acrylic acid is alkali-soluble and has the property of making a non-core shell type acrylic resin water-soluble by adding a neutralizing agent. By making the non-core-shell type acrylic resin water-soluble, the bondability to pigments is remarkably increased, when the protective layer contains a pigment, and the protective layer with excellent strength can be formed, even when a large amount of pigment is contained. As the monomer component copolymerizable with (meth) acrylic acid, for example, alkyl acrylate resins, such as methyl (meth) acrylate, ethyl (meth) acrylate, propyl (meth) acrylate, butyl (meth) acrylate, isobutyl (meth) acrylate, pentyl (meth) acrylate, hexyl (meth) acrylate, 2-ethyl hexyl (meth)acrylate, octyl (meth) acrylate, and the like; epoxy resins; silicone resins; modified alkyl acrylate resins, such as alkyl acrylate resin modified with styrene or its derivative; (meth) acrylonitrile; acrylic acid ester; hydroxyalkyl acrylic acid ester and the like may be listed. The monomer is preferably (meta) acrylonitrile and/or methyl methacrylate. It is preferable to formulate from 15 to 70 parts of (meth) acrylonitrile per 100 parts of the non-core shell type acrylic resin. Further, it is preferable to formulate from 20 to 80 parts of methyl methacrylate per 100 parts of a non-core shell type acrylic resin. When both (meth) acrylonitrile and methyl methacrylate are contained, It is preferable to formulate from 15 to 18 parts of (meth) acrylonitrile and from 20 to 80 parts of methyl methacrylate per 100 parts of a non-core shell type acrylic resin.

The epichlorohydrin resin is a resin characterized by containing an epoxy group in the molecule, and examples thereof include, poly(amide epichlorohydrin) resins, poly(amine epichlorohydrin) resins and the like and these can be used individually or in combinations. In addition, primary to quaternary amines may be used as the amine that is present in the main chain of an epichlorohydrin resin, and no particular restrictions apply. Furthermore, a degree of cationization of no greater than 5 meq/g solid (measured at pH 7) and a molecular weight of at least 500,000 are preferred from the view point of good water resistance. Sumirez Resin 650 (30), Sumirez Resin 675A, Sumirez Resin 6615 (the above, Sumitomo Chemical Co., Ltd.), WS4002, WS 4020, WS4024, WS4030, WS4046, WS4010, CP8970 (the above, Seiko PMC Corporation) may be cited as specific examples.

The polyamine/amide resin does not contain epoxy group in the molecule, and examples of the polyamine/amide resin include polyamide urea resins, polyalkylene polyamine resins, polyalkylene polyamide resins, polyamine polyurea resins, modified polyamine resins, modified polyamide resins, polyalkylene polyamine urea formalin resins, and polyalkylene polyamine polyamide polyurea resins. These may be used individually or as mixtures of at least two of them. Specific examples of the polyamine/amide resin include Sumirez resin 302 (polyamine polyurea resin produced by Sumitomo Chemical Co., Ltd.), Sumirez resin 712 (polyamine polyurea resin produced by Sumitomo Chemical Co., Ltd.), Sumirez resin 703 (polyamine polyurea resin produced by Sumitomo Chemical Co., Ltd.), Sumirez resin 636 (polyamine polyurea resin produced by Sumitomo Chemical Co., Ltd.), Sumirez resin SPI-100 (modified polyamine resin produced by Sumitomo Chemical Co., Ltd.), Sumirez resin SPI-102A (modified polyamine resin produced by Sumitomo Chemical Co., Ltd.), Sumirez resin SPI-106N (modified polyamide resin produced by Sumitomo Chemical Co., Ltd.), Sumirez resin SPI-203(50)(Sumitomo Chemical Co., Ltd.), Sumirez resin SPI-198 (Sumitomo Chemical Co., Ltd.), PrintiveA-700 (Asahi Kasei Corporation), PrintiveA-600 (Asahi Kasei Corporation), PA6500, PA6504, PA6634, PA6638, PA6640, PA6644, PS6646, PA6654, PA6702, PA 6704 (the above, polyalkylene polyamine polyamide polyurea resins produced by Seiko PMC Corporation), and CP8994 (polyethyleneimine resin produced by Seiko PMC Corporation). From the viewpoint of print intensity (recording intensity), polyamine resins (polyalkylene polyamine resins, polyamine polyurea resins, modified polyamine resins, polyalkylene polyamine urea formalin resins, and polyalkylene polyamine polyamide polyurea resins) are preferable.

When the protective layer contains epichlorohydrin resins and polyamine/amide resins together with carboxy-modified poly(vinyl alcohol), each content of epichlorohydrin resins and polyamine/amide resins is preferably from 1 to 100 parts, more preferably from 5 to 50 parts, further preferably from 10 to 40 parts per 100 parts of carboxy-modified poly(vinyl alcohol).

As a pigment used in the protective layer, the pigments described as usable for the thermosensitive recording layer can be used, and preferably kaolin, calcined kaolin, aluminum hydroxide, silica are used. These may be used individually and as mixtures of at least two of them.

The content (in solid) of the binder in the protective layer is preferably 20 weight % or higher, more preferably from 20 to 80 weight %. When the protective layer contains pigments, the content (in solid) of binder is from 30 parts to 300 parts per 100 part of pigments.

If necessary, the coating solution for the protective layer may further contain cross-linking agents, slipping agents, stabilizers, and various auxiliary agents such as UV absorbing agents, dispersants, defoaming agents, antioxidants, fluorescent dyes, etc. that can be used for the above-mentioned thermosensitive recording layer.

The thermosensitive recording medium to be intended is obtained by coating the substrate with a coating liquid formulated for each coating layer described above. Combined sheets combining these may be used as the substrate.

Electron donating leuco dye, an electron accepting color developing agent, an electron acceptor, an electronic donor, and materials added as necessary are pulverized to a particle size of a few microns or less by a pulverizer such as a ball mill, an attritor, a sand grinder, or other appropriate emulsifying device. Various additives are added thereto depending on the purpose to make the coating liquid.

The method for coating above individual coating layers are not limited in particular, but any known conventional techniques may be used. The method for coating may be appropriately selected from off-machine coating machines and on-machine coating machines, which are equipped with coaters such as air knife coater, rod blade coater, bent blade coater, bevel blade coater, roll coater, curtain coater, spray coater and the like. The coating amounts of the thermosensitive recording layer is not limited in particular, but may be determined according to the required performance and the recording suitability. The typical coating amount (in solid) of the thermosensitive recording layer is ordinarily in the range of from 2 to 12 g/m².

Furthermore, various technologies known in the thermosensitive recording medium field, such as a flattening treatment such as super calendaring and the like can be applied as needed after coating individual coating layers.

### EXAMPLES

The following Examples illustrate the present invention, but the Examples are not intended to limit the scope of the present invention. In the following description, the terms parts and % indicate parts by weight and weight %, respectively.

Each of color developing agent dispersion (A1 to A4 liquid), leuco dye dispersion (B liquid), and sensitizer dispersion (C liquid) having the following blend was wet ground separately by a sand grinder to an average particle size of 1.0 μm.

### Color Developing Agent Dispersion (A1 Liquid)

| | | |
|---|---|---|
| N,N′-di-[3-(p-toluenesulfonyloxy)phenyl] urea | 6.0 | parts |
| (hereinafter referred to as “urea compound 1”) | | |
| Fully saponified polyvinyl alcohol aqueous | 18.8 | parts |
| solution (PVA117) | | |
| Water | 11.2 | parts |

### Color Developing Agent Dispersion (A2 Liquid)

| | | |
|---|---|---|
| N-[2-(3-phenylureido)phenyl]benzenesulfonamide | 6.0 | parts |
| (hereinafter referred to as “urea compound 2”) | | |
| Fully saponified polyvinyl alcohol aqueous | 18.8 | parts |
| solution (PVA117) | | |
| Water | 11.2 | parts |

### Color Developing Agent Dispersion (A3 Liquid)

| | | |
|---|---|---|
| 4,4′-bis(3-(phenoxycarobonylamino)methyl- | 6.0 | parts |
| phenylureido)diphenyl sulfone | | |
| (manufactured by Fine Ace Co., Ltd., product name: UU) | | |
| Fully saponified polyvinyl alcohol aqueous | 18.8 | parts |
| solution (PVA117) | | |
| Water | 11.2 | parts |

### Color Developing Agent Dispersion (A4 Liquid)

| | | |
|---|---|---|
| 4-hydroxy-4′-isopropoxydiphenyl sulfone | 6.0 | parts |
| (manufactured by Nippon Soda Co., Ltd., | | |
| product name: D8) | | |
| Fully saponified polyvinyl alcohol | 18.8 | parts |
| aqueous solution (PVA117) | | |
| Water | 11.2 | parts |

### Leuco Dye Dispersion (B Liquid)

| | |
|---|---|
| 3-di-n-buthylamino-6-methyl-7-anilinofluoran | 2.0 parts |
| (manufactured by Yamamoto Chemicals, Inc., ODB-2) | |
| Fully saponified polyvinyl alcohol aqueous solution (PVA117) | 4.6 parts |
| Water | 2.6 parts |

### Sensitizer Dispersion (C Liquid)

| | |
|---|---|
| 4-biphenyl-p-tolyl ether (manufactured by | 4.0 parts |
| Nikka Chemical Co., Ltd.) | |
| Fully saponified polyvinyl alcohol aqueous | 5.0 parts |
| solution (PVA117) | |
| Water | 3.0 parts |

Next, each dispersion was mixed in the following percentage to prepare a coating material for the thermosensitive recording layer.

### <Coating Material for Thermosensitive Recording Layer 1>

| | | |
|---|---|---|
| Color developing agent dispersion (A1 liquid) | 36.0 | parts |
| Leuco dye dispersion (B liquid) | 9.2 | parts |
| Sensitizer dispersion (C liquid) | 12.0 | parts |

### <Coating Material for Thermosensitive Recording Layer 2>

| | | |
|---|---|---|
| Color developing agent dispersion (A1 liquid) | 20.0 | parts |
| Color developing agent dispersion (A3 liquid) | 16.0 | parts |
| Leuco dye dispersion (B liquid) | 9.2 | parts |
| Sensitizer dispersion (C liquid) | 12.0 | parts |

Next, an adhesive coating material having the following blend was prepared.

### <Adhesive Coating Material>

| | | |
|---|---|---|
| Waer soluble acrylic adhesive agent | 100 | parts by weight |
| (manufactured by VIGteQnos Corporation, | | |
| produce name | | |
| “Liquidyne AR-2410”, solid content | | |
| concentration 42% by weight) | | |
| Curing agent (manufactured by VIGteQnos | 0.1 | parts by weight |
| Corporation, produce name “Sunpsta HD-5013”) | | |

### Example 1

An internal layer including a raw material for paper making obtained by beating mixed pulp to the Canadian Standard Freeness 675 ml CSF, the mixed pulp including 70% by weight of, as the wood pulp, softwood bleached kraft pulp (α cellulose content percentage of 85.6% by weight), and 30% by weight of, as the refined pulp, hardwood dissolving pulp (α cellulose content percentage of 98.3% by weight, and surface layers each of which includes a raw material for paper making obtained by beating mixed pulp to the Canadian Standard Freeness 500 ml CSF, the mixed pulp including 15% by weight of, as the wood pulp, softwood bleached kraft pulp (a cellulose content percentage of 85.6% by weight), 55% by weight of hardwood bleached kraft pulp (α cellulose content percentage of 86.0% by weight), and 30% by weight of, as the refined pulp, hardwood dissolving pulp (α cellulose content percentage of 98.3% by weight) were laminated by paper joining such that a weight ratio of the surface layer:the internal layer:the surface layer=1:4:1 to produce a three-layered hand-made paper. The pH of the paper surface was 6.7.

The hand-made paper was coated with a solution (pH7.1) of, as a water-soluble polymer, carboxymethyl cellulose sodium salt (CMC-Na, manufactured by Nippon Paper Industries Co., Ltd., product name: Sunrose, viscosity of 2% by weight solution at 20° C. is 5 mPa·s) (hereinafter also referred to as “CMC-Na”) by a size press coating in 8% by weight with respect to the hand-made paper to produce a water dispersible sheet (base paper).

The surface (hereinafter referred to as a “second surface layer”) of the base paper was coated with a coating material for thermosensitive recording layer 1 so as to be 6 g/m² as solid content and was dried (50° C.) to form a thermosensitive recording layer, thereby providing a thermosensitive recording paper. The thermosensitive recording paper was subjected to a smoothing treatment such that the Bekk smoothness is 500 to 1000 seconds.

A part of the resultant thermosensitive recording paper was held for evaluation described later, and next treatment was performed on the other parts.

A release-treated surface of a commercial release sheet coated with a silicone release agent was coated with 25 g/m² of the adhesive coating material as solid content, and was dried to arrange an adhesive layer. The adhesive layer was adhered to a surface (a first surface layer) opposite to the thermosensitive recording layer of the thermosensitive recording paper to produce a thermosensitive recording label having the water dispersibility.

### Example 2

A thermosensitive recording paper and a thermosensitive recording label were prepared in the same manner as described in Example 1 with the exception of changing the coating material for thermosensitive recording layer 1 to the coating material for thermosensitive recording layer 2.

### Example 3

A thermosensitive recording paper and a thermosensitive recording label were prepared in the same manner as described in Example 1 with the exception of changing the color developing agent dispersion (A1 liquid) of the coating material for thermosensitive recording layer 1 to the color developing agent dispersion (A2 liquid).

### Comparative Example 1

A thermosensitive recording paper and a thermosensitive recording label were prepared in the same manner as described in Example 1 with the exception of changing the color developing agent dispersion (A1 liquid) of the coating material for thermosensitive recording layer 1 to the color developing agent dispersion (A3 liquid).

### Comparative Example 2

In the base paper, an internal layer including a raw material for paper making, in which 67 parts by weight of pulp including 15% by weight of softwood bleached kraft pulp and 85% by weight of hardwood bleached kraft pulp that was beaten to Canadian Standard Freeness 670 ml CSF and 33 parts by weight of fibrous carboxymethyl cellulose (manufactured by Nichirin Chemical Industries, Ltd. CMC-CB, the degree of etherification of 0.43) (hereinafter referred to as “CMC”) were blended, and surface layers each of which includes the raw material for paper making, in which 67 parts by weight of the pulp (the same described above) beaten to Canadian Standard Freeness 500 ml CSF and 33 parts by weight of the fibrous carboxymethyl cellulose (the same described above) were blended were laminated by paper joining such that a weight ratio of the surface layer:the internal layer:the surface layer=1:2:1 to produce a three-layered hand-made paper. The hand-made paper was immersed and coated with 10% by weight of a 2.5% by weight solution of sodium carbonate (soda ash light manufactured by Tokuyama Corporation) by a size press method to produce the base paper.

The thermosensitive recording paper and the thermosensitive recording label were produced similar to Example 1 except that the color developing agent dispersion (A1 liquid) of the coating material for thermosensitive recording layer 1 was changed to the color developing agent dispersion (A3 liquid).

### Comparative Example 3

A thermosensitive recording paper and a thermosensitive recording label were produced similar to Example 1 except that carboxymethyl cellulose sodium salt (CMC-Na) was not coated by the size press coating.

### Comparative Example 4

A thermosensitive recording paper and a thermosensitive recording label were prepared in the same manner as described in Comparative Example 3 with the exception of changing the color developing agent dispersion (A1 liquid) of the coating material for thermosensitive recording layer 1 to the color developing agent dispersion (A2 liquid).

### Reference Example 1

A thermosensitive recording paper and a thermosensitive recording label were prepared in the same manner as described in Comparative Example 1 with the exception of changing the color developing agent dispersion (A1 liquid) of the coating material for thermosensitive recording layer 1 to the color developing agent dispersion (A4 liquid).

The prepared thermosensitive recording media were evaluated as below.

### <Color Developing Property (Recorded Density)>

A checkerboard pattern was printed on the prepared thermosensitive recording media by using a thermosensitive recording medium print tester (Okura Engineering Co., Ltd. TH-PMD equipped with a thermal head by KYOCERA Corporation) at applied energy of 0.41 mJ/dot and printing speed of 50 mm/sec. The density of the printed portion was measured by using Macbeth Densitometer (RD-914, with Amber filter) to evaluate the color developing property (recorded density).

<Reprintability> (Color Development Sensitivity after Storage)

The produced thermosensitive recording paper was stored under the condition of 40° C., 90% RH for 96 hours. The thermosensitive recording paper after storage was solid-printed by using TH-PMD manufactured by Okura Engineering Co., Ltd. (thermosensitive recording paper printing tester, mounted thermal head manufactured by KYOCERA Corporation) with applied energy of 0.27 mJ/dot at a printing speed of 50 mm/sec. Recorded density of a solid-printed part was measured by using the Macbeth densitometer (RD-914, amber filter used) to evaluate the color development sensitivity after storage.

### <Wet and Heat Resistance>

A checkboard pattern was printed on the produced thermosensitive recording paper by using TH-PMD manufactured by Okura Electric Co., Ltd. (thermosensitive recording paper printing tester, mounted thermal head manufactured by KYOCERA Corporation) with applied energy of 0.41 mJ/dot at a printing speed of 50 mm/sec. After the printed thermosensitive recording paper was allowed to stand under the condition of 40° C., 50% RH for 24 hours, recorded density of a printed part was measured by using the Macbeth densitometer (RD-914, amber filter used) to calculate a remaining percentage from values before and after the treatment and to evaluate wet and heat resistance.

$$Remaining percentage ( \% ) = ( recorded density of printed part after treatment / recorded density of printed part before treatment ) \times 100$$

Excellent: Remaining percentage is 90% or more
Fair: Remaining percentage is 70% or more, less than 90%
Poor: Remaining percentage is less than 70%

### <Plasticizer Resistance>

Checkerboard pattern was printed on the prepared thermosensitive recording paper by using TH-PMD manufactured by Okura Electric Co., Ltd. (thermosensitive recording paper printing tester, mounted thermal head manufactured by KYOCERA Corporation) with applied energy of 0.41 mJ/dot at a printing speed of 50 mm/sec.

A paper tube was wrapped once with polyvinyl chloride wrap (Mitsui Chemicals: High Wrap KMA) and the thermosensitive recording paper was placed on the wrapped paper tube so that the recorded face is the outer face. Furthermore, the tube was wrapped 3 times with polyvinyl chloride wrap and was left standing for 24 hours under the condition of 23 degree C., 50% RH.

The record density of the recorded section was measured by using Macbeth densitometer (RD-914, with amber filter), and the residual ratio was calculated from the measured value before and after the treatment to evaluate plasticizer resistance.

$$Residual ratio ( \% ) = ( record density after the treatment / record density before the treatment ) \times 100$$

Excellent: The residual rate is 70% or more
Fair: The residual rate is 50% or more and less than 70%
Poor: The residual rate is less than 50%

### <Solvent Resistance>

A white part of the produced thermosensitive recording paper was coated with ethanol (99.5%) by a cotton swab and was allowed to stand under the condition of 23° C.×50% RH for 24 hours to visually evaluate by the following criteria:
Excellent: No coloration at all
Fair: Slight coloration
Poor: Strong coloration

On 14 days after the produced thermosensitive recording paper on which the adhesive agent was coated was stored at room temperature (23° C., 50% RH), the following evaluations were conducted. At the time of testing the water dispersibility, the evaluation was conducted after the release sheet was peeled.

### <Water Solubility>

Five 3 cm square test pieces were produced from a sample of the thermosensitive recording paper. Next, 300 ml of deionized water was added to a 300 ml beaker and stirred at 650 rpm with a stirrer while one of the above test pieces was fed into the beaker. The time taken by a stopwatch for the test piece to break into individual fibers and become fibrous was determined. When the average value of five measurements was within 300 seconds, it determined that the water solubility was present. When the average value exceeded 300 seconds, it determined that the water solubility was absent.

In addition, with respect to the produced thermosensitive recording label, the following evaluations were conducted.

### <Water Dispersibility>

Five 3 cm square test pieces were produced from a sample of the thermosensitive recording label. Next, 300 ml of deionized water was added to a 300 ml beaker and stirred at 650 rpm with a stirrer while one of the above test pieces was fed into the beaker. The time that the test piece shreds into two or more pieces and becomes flock was determined with a stopwatch, and the average of five measurements was used as the water dispersion time. The shorter the water dispersion time is, the better the water dispersion is.

### <Adhesive Strength>

In accordance with JIS Z0237, three test pieces of 25 mm wide×250 mm long were cut out, the release paper was peeled off and an adhesive coated surface was placed on a stainless steel plate (100×150 mm), and a rubber roller weighing 3 kg was rolled back and forth twice to apply pressure.

The stainless steel plate was clamped in a lower chuck of a tensile tester, one end of an adhesive processed sample was folded 180° and clamped in an upper chuck, and a 180° peeling test was conducted at a tensile speed of 300 mm/min to measure the adhesive strength (g/25 mm). If a percentage of the adhesive strength on day 14 to that on the first day (day 1) is 60% or more, the adhesion over time is considered to be good.

### <Image Quality (Print Image Quality)>

After 14 days elapsed since the thermal recording label was produced, a surface of the thermosensitive recording layer was printed a gradation pattern by using TH-PMD manufactured by Okura Electric Co., Ltd. (thermosensitive recording paper printing tester, mounted thermal head manufactured by KYOCERA Corporation), increasing the applied energy from 0.150 mJ/dot to 0.345 mJ/dot in 0.015 mJ/dot increments. Fineness of the printed part in this range was evaluated visually and the print image quality was evaluated based on the following criteria. The better the print image quality is, the better the surface (the second surface layer) of the thermal recording paper is.
Excellent: Printing with no printing unevenness
Good: Almost no printing unevenness
Fair: Some printing unevenness, but within allowable range.
Poor: Significant whiteout in the printed part can be seen.

The results are shown in Table below.

TABLE 1

| | | | | | | | | | | Refer- |
|---|---|---|---|---|---|---|---|---|---|---|
| | | | | | | Comp- | Comp- | Comp- | Comp- | ence |
| | | | Exam- | Exam- | Exam- | Exam- | Exam- | Exam- | Exam- | Exam- |
| | | | ple 1 | ple 2 | ple 3 | ple 1 | ple 2 | ple 3 | ple 4 | ple 1 |
| Substrate | | | CMC-Na size press | | | | CMC-Na | No CMC-Na | | CMC-Na |
| | | | | | | | containing | size press | | size press |
| | | | — | — | — | — | Alkalizing | — | — | — |
| | | | | | | | agent | | | |
| Color | Urea compound 1 | | ◯ | ◯ | — | — | — | ◯ | — | — |
| developing | Urea compound 2 | | — | — | ◯ | — | — | — | ◯ | — |
| agent | UU | | — | ◯ | — | ◯ | ◯ | — | — | — |
| | D8 | | — | — | — | — | — | — | — | ◯ |
| Performance of | Color developing | O.D. value | 1.36 | 1.40 | 1.38 | 1.35 | 1.20 | 1.38 | 1.32 | 1.36 |
| thermosensitive | performance | | | | | | | | | |
| recording | Reprintability | Printed part | 1.28 | 1.29 | 1.26 | 0.71 | 0.21 | 1.29 | 1.24 | 1.24 |
| paper | Wet and heat | Remaining | 96 | 98 | 98 | 83 | 40 | 91 | 93 | 89 |
| | resistance | percentage of | | | | | | | | |
| | | printed | | | | | | | | |
| | | part [%] | | | | | | | | |
| | Plasticizer | Remaining | 72 | 90 | 96 | 70 | 32 | 76 | 71 | 72 |
| | resistance | percentage of | | | | | | | | |
| | | printed | | | | | | | | |
| | | part[%] | | | | | | | | |
| | Solvent resistance | | Excellent | Excellent | Excellent | Poor | Poor | Excellent | Excellent | Excellent |
| | Water solubility | | Present | Present | Present | Present | Present | Absent | Absent | Absent |
| Performance of | Water dispersion time | s | 8.1 | 7.9 | 7.5 | 8.1 | 16.4 | | | |
| thermosensitive | Adhesive strength | g/25 mm | 1068 | 1102 | 1151 | 1171 | 1086 | | | |
| recording | on first day | | | | | | | | | |
| label | Adhesive strength | g/25 mm | 903 | 941 | 917 | 940 | 767 | | | |
| | on 14 days | | | | | | | | | |
| | Adhesive strength | % | 85 | 85 | 80 | 80 | 71 | | | |
| | percentage | | | | | | | | | |
| | (14 day/first day) | | | | | | | | | |

| | | | | | | | | |
|---|---|---|---|---|---|---|---|---|
| Image quality | Excellent | Excellent | Good | Poor | Poor | Excellent | Excellent | Excellent |

1. A thermosensitive recording medium, comprising:
a thermosensitive recording layer containing colorless or pale colored electron donating leuco dye and an electron accepting color developing agent on a substrate, wherein the thermosensitive recording layer contains at least one of a urea compound represented by the following general formula (Formula 1) as the electron accepting color developing agent 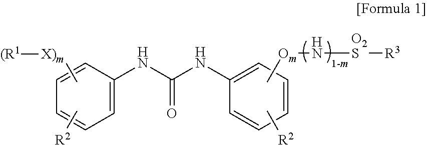
(where, X represents —O— or —NH—, R¹ represents a hydrogen atom or —SO₂—R³, R³ represents a substituted or unsubstituted alkyl group, an aralkyl group or aryl group, R² represents a hydrogen atom or alkyl group, and m represents 0 or 1), and wherein the substrate consists of a paper base material having water dispersibility.

2. The thermosensitive recording medium according to claim 1, wherein the paper base material is any of the following (1) to (3):
(1) a paper base material including an internal layer and two surface layers arranged on each of both surfaces of the internal layer, in which each surface layer includes mixed pulp including wood pulp and refined pulp including an α cellulose content percentage of 88% by weight or more, in which Canadian Standard Freeness of the mixed pulp is 450 to 600 ml CSF, in which content of the wood pulp in the mixed pulp is 50 to 95% by weight, in which the internal layer includes second mixed pulp including wood pulp and refined pulp including an α cellulose content percentage of 88% by weight or more, in which Canadian Standard Freeness of the second mixed pulp is 600 to 750 ml CSF, and in which content of the wood pulp in the second mixed pulp is 50 to 95% by weight,
(2) a paper base material including an internal layer and two surface layers arranged on each of both surfaces of the internal layer, in which the internal layer includes papermaking fiber having the Canadian Standard Freeness of 600 to 750 ml CSF and alkalized fibrous carboxyalkylmethyl cellulose, in which each of the surface layers includes independently the papermaking fiber and the alkalized fibrous carboxyalkylmethyl cellulose, in which the papermaking fiber in at least one surface layer has the Canadian Standard Freeness of 400 to 575 ml CSF, and in which content of the papermaking fiber is 60 to 90% by weight, and
(3) a paper base material including a papermaking fiber and alkalized fibrous carboxyalkyl cellulose, and further including a carboxyalkyl cellulose salt, in which a degree of etherification of the fibrous carboxyalkyl cellulose is 0.2 to 0.6, in which a degree of etherification of the carboxyalkyl cellulose salt is 0.5 to 1.6, in which viscosity measured by the Brookfield viscometer of a 1% by weight solution of the carboxyalkyl cellulose salt is 2 to 200 mPa·s, and in which a percentage of the carboxyalkyl cellulose salt to a total of the papermaking fiber and the alkalized fibrous carboxyalkyl cellulose is 0.1 to 10% by weight.

3. The thermosensitive recording medium according to claim 1, wherein the urea compound is following (1) or (2):
(1) a first urea compound represented by the following general formula (Formula 2), 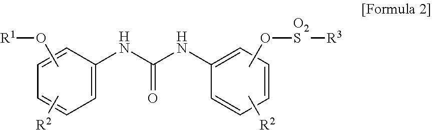
(where R¹, R², and R³ are defined as described above)
(2) a second urea compound represented by the following general formula (Formula 3), 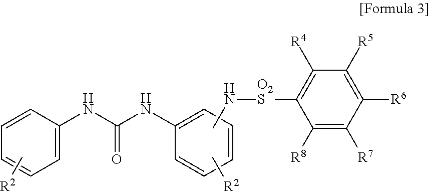
(where R² is defined as described above, and R⁴ to R⁸ may be identical or different from each other, and each represents a hydrogen atom, a halogen atom, a nitro group, an amino group, an alkyl group, an alkoxy group, an aryloxy group, an alkylcarbonyloxy group, an arylcarbonyloxy group, an alkylcarbonylanimo group, an arylcarbonylamino group, an alkylsulfonylamino group, an arylsulfonylamino group, a monoalkylamino group, a dialkylamino group, or an arylamino group).

4. The thermosensitive recording medium according to claim 3, wherein the first urea compound is represented by the following general formula (Formula 4), 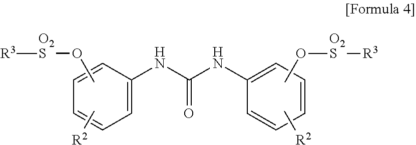
(where, R² is defined as described above, R³ may be identical or different from each other, and is a group represented by the following general formula (Formula 5), and a position of R³—SO₃—O— in a benzene ring of the general formula (Formula 4) may be identical or different and is in the 3-, 4- or 5-position) 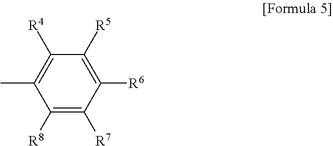
(where, R⁴ to R⁸ may be identical or different from each other, and each represents a hydrogen atom, a halogen atom, a nitro group, an amino group, an alkyl group, an alkoxy group, an aryloxy group, an alkylcarbonyloxy group, an arylcarbonyloxy group, an alkylcarbonylanimo group, an arylcarbonylamino group, an alkylsulfonylamino group, an arylsulfonylamino group, a monoalkylamino group, a dialkylamino group, or an arylamino group).

5. The thermosensitive recording medium according to claim 3, wherein the first urea compound is represented by the following general formula (Formula 6), 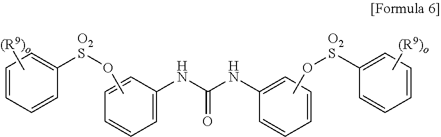
(where R⁹ may be identical or different from each other, and represents an alkyl group or an alkoxy group, and o represents an integer of 0 to 3).

6. The thermosensitive recording medium according to claim 5, wherein in the first urea compound, R⁹ represents an alkyl group having 1 to 4 carbon atoms, o represents an integer of 0 to 1, and the position of R⁹ in the benzene ring is the 4-position.

7. The thermosensitive recording medium according to claim 3, wherein the second urea compound is N-[2-(3-phenylureido)phenyl]benzenesulfonamide.

8. The thermosensitive recording medium according to claim 1, wherein content (solid content) of the urea compound in the thermosensitive recording layer is 1.0 to 70.0% by weight.

9. The thermosensitive recording medium according to claim 1, wherein the thermosensitive recording layer contains a color developing agent other than the first urea compound and the second urea compound, and total content (solid content) of the first urea compound and the second urea compound in the thermosensitive recording layer is 90% by weight or more with respect to all color developing agents contained in the thermosensitive recording layer.

10. The thermosensitive recording label according to claim 1, wherein an adhesive layer is arranged on a surface opposite to the surface of the substrate on which the thermosensitive recording layer is arranged.
